(19) United States
(12) Patent Application Publication
(10) Pub. No.: US 2012/0075510 A1
(43) Pub. Date: Mar. 29, 2012

(54) COLOR CAMERA

(75) Inventors: Hidenori SATO, Fujieda-city (JP); Yoshiyuki TERADA, Fujieda-city (JP)

(73) Assignee: MURAKAMI CORPORATION, Shizuoka (JP)

(21) Appl. No.: 13/170,895

(22) Filed: Jun. 28, 2011

(30) Foreign Application Priority Data
Sep. 29, 2010 (JP) 2010-219824

(51) Int. Cl. H04N 9/04

(52) U.S. Cl. 348/273; 348/E09.002

(57) ABSTRACT

The present invention enables switching between bright-light shooting and low-light shooting with an infrared cut filter placed on an optical path. An optical system captures and focuses image light from a subject. The focused image light passes through a multilayer infrared cut filter placed on an optical path of the image light and forms an image on an imaging device. The imaging device has sensitivity to at least the visible to near-infrared region. The infrared cut filter is constructed by forming a multilayer dielectric film on a surface of a transparent substrate. The infrared cut filter has a cutoff wavelength near a boundary between the visible region and near-infrared region and is configured so as to have a high incident-angle dependence. An angle of the infrared cut filter with respect to an optical axis of the optical system is varied by an incident angle varying mechanism according to an amount of light on the subject, shifting the cutoff wavelength.

The disclosure of Japanese Patent Application No. JP2010-219824 filed on Sep. 29, 2010 including the specification, drawings, claims and abstract is incorporated herein by reference in its entirety.

### BACKGROUND OF THE INVENTION

1. Field of the Invention

The present invention relates to a color camera which obtains color video images using an imaging device, the color camera being configured to be able to switch between bright-light shooting (daylight photographing) and low-light shooting (nighttime photographing) with an infrared cut filter placed on an optical path.

2. Description of the Related Art

An imaging device such as a CCD used for a color camera has sensitivity to the visible to infrared region. This presents a problem in that during bright-light shooting, image color reproducibility is adversely affected by infrared radiation contained in image light from a subject (resulting in unnatural coloration). To solve this problem, an infrared cut filter is placed in front of the imaging device in a typical color camera. However, the infrared cut filter, which impairs night vision, gets in the way of low-light shooting. In the case of a vehicle-mounted color camera, for example, when the vehicle moves backward in the nighttime, the camera captures the field of view behind the vehicle illuminated by back-up lights and displays the view on a monitor. Tungsten lamps of the back-up lights have light emission characteristics which show high intensity in the infrared region, and if the color camera is fitted with an infrared cut filter, the infrared region is cut off, darkening video images displayed on the display screen and degrading visibility in the field of view behind the vehicle. Thus, to enable both bright-light shooting and low-light shooting, Japanese Patent Laid-Open No. 2005-109630 discloses a technique which, by installing a mechanism adapted to mechanically slide an infrared cut filter in and out of an optical path, places the infrared cut filter on the optical path for bright-light shooting and retracts the infrared cut filter from the optical path for low-light shooting.

The technique disclosed in Japanese Patent Laid-Open No. 2005-109630 requires a space for use to slide the infrared cut filter in and out of the optical path. When the infrared cut filter is slid in and out of the optical path to switch between bright-light shooting and low-light shooting during shooting of moving images, there is a problem in that edges of the infrared cut filter may pass the optical path and thereby appear in video images.

Therefore, to prevent the edges from appearing in the video images, it is necessary to stop shooting once before sliding the infrared cut filter in or out of the optical path.

### SUMMARY OF THE INVENTION

The present invention has been made in view of the above circumstances and has an object to provide a color camera which can switch between bright-light shooting and low-light shooting with an infrared cut filter placed on an optical path.

A color camera according to the present invention comprises: an optical system adapted to focus image light from a subject; an imaging device having sensitivity to at least the visible to near-infrared region and adapted to project an image focused by the optical system and thereby generate a video signal; a multilayer infrared cut filter placed at any location on an optical path running from the subject to the imaging device, with a cutoff wavelength being set in the vicinity of a boundary between the visible region and the near-infrared region, and adapted to allow passage of the near-infrared region close to the boundary with the visible region when an incident angle is small and shift the cutoff wavelength toward shorter wavelengths with increases in the incident angle to decrease passage of the near-infrared region; an incident angle varying mechanism adapted to vary the incident angle of the image light from the subject with respect to the multilayer infrared cut filter; and a drive unit adapted to drive the incident angle varying mechanism according to the amount of light on the subject by an operator's operation or automatically and thereby decrease the incident angle when an amount of light on the subject is small or increase the incident angle when the amount of light on the subject is large. Being configured to change the cutoff wavelength of the multilayer infrared cut filter by varying the incident angle of the image light from the subject with respect to the multilayer infrared cut filter according to the amount of light on the subject using a property of the multilayer infrared cut filter whose cutoff wavelength changes with the incident angle (incident-angle dependence), the present invention can switch between bright-light shooting and low-light shooting without the need to slide the infrared cut filter in and out of the optical path.

Incidentally, Japanese Patent Laid-Open No. 6-281813 discloses a transmission wavelength varying apparatus which can vary a transmission wavelength by varying an incident angle of a multilayer film filter. Also, Japanese Patent Laid-Open No. 2000-206325 discloses a technique for adjusting an incident angle of a multilayer infrared cut filter and thereby finely adjusting a cutoff wavelength of the multilayer infrared cut filter after formation of a multilayer film. These techniques utilize incident-angle dependence of the multilayer film filter, but do not give any suggestion about using the incident-angle dependence for switching a color camera between bright-light shooting mode and low-light shooting mode.

### BRIEF DESCRIPTION OF THE DRAWINGS

FIG. 1 is a block diagram showing a first embodiment of the present invention;

FIG. 2 is a perspective view showing a configuration example of an electric drive source and incident angle varying mechanism shown in FIG. 1;

FIG. 3 is a chart showing a configuration example of a multilayer film of a multilayer infrared cut filter shown in FIG. 1;

FIG. 4 is a spectral transmittance characteristics curve of the multilayer infrared cut filter having the film configuration shown in FIG. 3;

FIG. 5 is a block diagram showing a second embodiment of the present invention;

FIG. 6 is a perspective view showing a configuration example of a control lever and incident angle varying mechanism shown in FIG. 5;

FIG. 7 is a block diagram showing a third embodiment of the present invention;

FIG. 8 is a perspective view showing a configuration example of an operation signal output unit shown in FIG. 7; and

FIG. 9 is a diagram showing another configuration example of an optical system according to the respective embodiments.

### DETAILED DESCRIPTION OF THE PREFERRED EMBODIMENTS

### First Embodiment

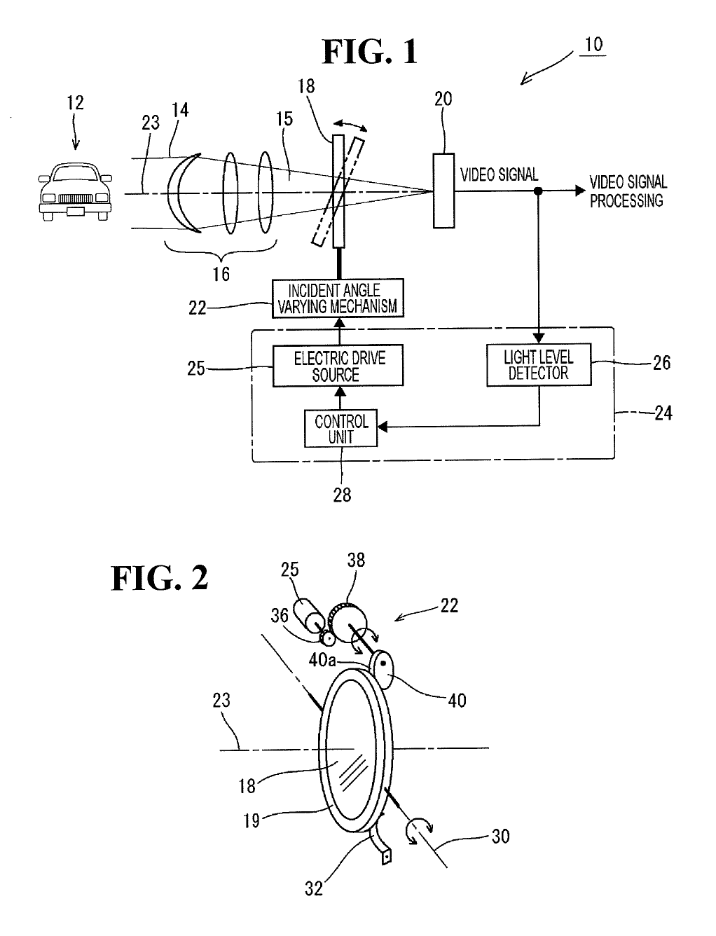

A first embodiment of a color camera according to the present invention is shown in FIG. 1. The color camera is configured to automatically vary an incident angle of an infrared cut filter according to an amount of light on a subject. In the color camera 10, an optical system 16 captures and focuses image light 14 from a subject 12. The focused image light 14 passes through a multilayer infrared cut filter (hereinafter simply referred to as an “infrared cut filter”) 18 placed on an optical path 15 of the image light 14 and forms an image on an imaging device 20. The imaging device 20, which is a color imaging device such as a CCD image sensor or CMOS image sensor, outputs a color video signal of the formed image of the subject 12. The imaging device 20 has sensitivity to at least the visible to near-infrared region. The color video signal outputted from the imaging device 20 is sent to a video signal processor and subjected to signal processing (such as processing for display on a display screen) as required.

The infrared cut filter 18 is constructed by forming a multilayer dielectric film on a surface of a transparent substrate. The infrared cut filter 18 has a cutoff wavelength near a boundary between the visible region and near-infrared region. Besides, the material, film thickness, and number of layers of multilayer film are set so as to have a high incident-angle dependence. An angle of the infrared cut filter 18 with respect to an optical axis 23 of the optical system 16 (an incident angle of the image light 14 from the subject 12 with respect to the infrared cut filter 18) is varied by an incident angle varying mechanism 22, shifting the cutoff wavelength with respect to the image light 14 from the subject 12. That is, when the incident angle is small (when the optical axis 23 intersects a plane of the infrared cut filter 18 at right angles or nearly right angles), the cutoff wavelength shifts toward longer wavelengths to allow passage of the near-infrared region close to the boundary with the visible region. The cutoff wavelength shifts toward shorter wavelengths with increases in the incident angle to decrease passage of the near-infrared region.

A drive unit 24 automatically drives the incident angle varying mechanism 22 according to the amount of light on the subject 12. That is, an electric drive source 25 of the drive unit 24 varies the incident angle of the infrared cut filter 18 by electrically driving the incident angle varying mechanism 22. A light level detector 26 detects the amount of light on the subject 12 based on the video signal outputted from the imaging device 20. A control unit 28 operates the electric drive source 25 according to the detected amount of light and thereby controls the incident angle of the infrared cut filter 18 by switching between two values. Specifically, when the detected amount of light is small (in the case of low-light shooting), the control unit 28 decreases the incident angle by shifting the cutoff wavelength toward longer wavelengths, and when the detected amount of light is large (in the case of bright-light shooting), the control unit 28 increases the incident angle by shifting the cutoff wavelength toward shorter wavelengths. Consequently, when the amount of light on the subject 12 is small (in the case of low-light shooting), the infrared cut filter 18 allows passage of the near-infrared region close to the boundary with the visible region and thereby improves night vision. When the amount of light on the subject 12 is large (in the case of bright-light shooting), the infrared cut filter 18 cuts off the near-infrared region or decreases passage of the near-infrared region and thereby improves color reproducibility. This enables both bright-light shooting and low-light shooting. Incidentally, although according to the above description, the amount of light is detected using a video signal, a photosensor may be installed separately as a light level detector to detect the amount of light.

A configuration example of the electric drive source 25 and incident angle varying mechanism 22 in FIG. 1 is shown in FIG. 2. The infrared cut filter 18 is rotatably supported around a rotation axis 30 orthogonal to the optical axis 23 of the optical system 16 by a supporting member (not shown). A holding ring 19 around an outer rim of the infrared cut filter 18 is abutted at one location by a leaf spring 32. The leaf spring is supported by the supporting member and adapted to impart an urging force around the rotation axis 30 to the infrared cut filter 18. Rotation of a motor 25 serving as the electric drive source is slowed by gears 36 and 38 and transmitted to a cam 40. By abutting a cam surface 40a of the cam 40 against the holding ring 19 of the infrared cut filter 18 urged by the leaf spring 32 at another location, the cam surface 40a of the cam 40 rotates the infrared cut filter 18 around the rotation axis 30 to change the incident angle.

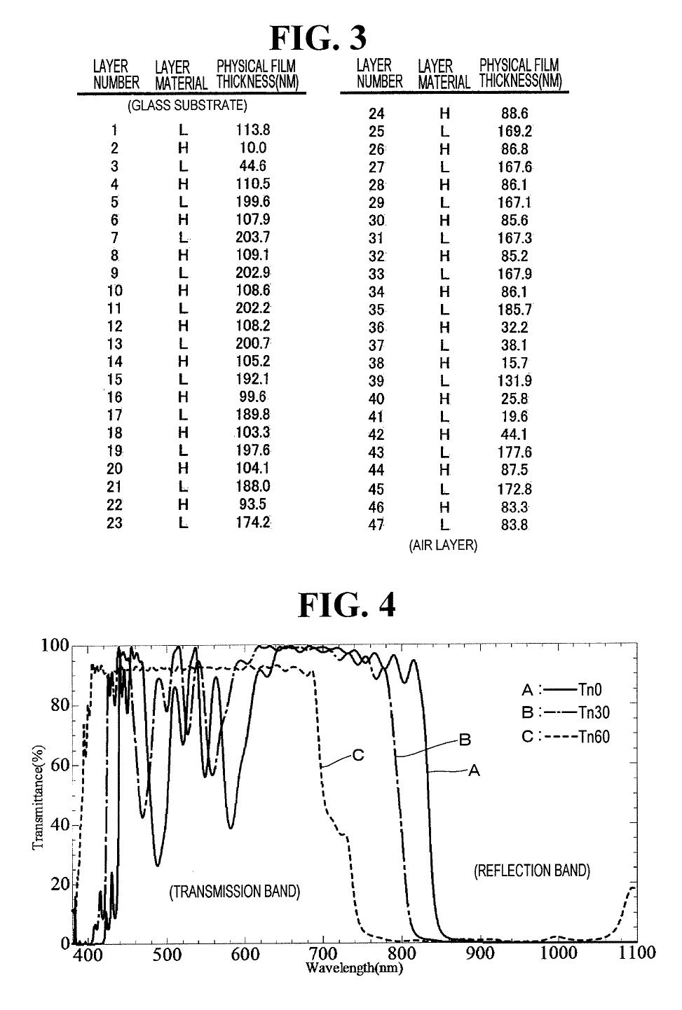

A configuration example of the multilayer film of the infrared cut filter 18 in FIG. 1 will be described. As described above, the multilayer film of the infrared cut filter 18 is configured so as to have a high incident-angle dependence. To have a high incident-angle dependence, the multilayer film can be designed so as to minimize the average refractive index of the entire multilayer film. In order to realize this, the proportion of the total thickness of low-refractive-index films in the film thickness of the entire multilayer film can be high. FIG. 3 shows a design example of a multilayer film made up of 47 layers, where “L” represents a low-refractive-index film (a thin film made of a low-refractive-index dielectric material) which, in this case, is made of SiO₂ (with a refractive index of 1.4679 at a wavelength of 900 nm) while “H” represents a high-refractive-index film (a thin film made of a high-refractive-index dielectric material) which, in this case, is made of TiO₂ (with a refractive index of 2.2743 at a wavelength of 900 nm). The refractive index of a glass substrate is 1.5101 (at a wavelength of 900 nm). Transmittance characteristics of the infrared cut filter 18 with the film configuration in FIG. 3 are shown in FIG. 4, where solid line A represents an incident angle of 0°, chain line B represents an incident angle of 30°, and broken line C represents an incident angle of 60°. In FIG. 4, at incident angles of 30° and 0°, the cutoff wavelength at a 50% transmittance (half value) shifts toward a longer wavelength than 750 nm, and at an incident angle of 60°, the cutoff wavelength shifts toward a shorter wavelength than 750 nm. More specifically, at an incident angle of 60°, the cutoff wavelength at a 50% transmittance is 700 nm. Also, the cutoff wavelength at a 50% transmittance shifts 133 nm when the incident angle changes from 60° to 0° or vice versa, and shifts 38 nm when the incident angle changes from 30° to 0° or vice versa.

### Second Embodiment

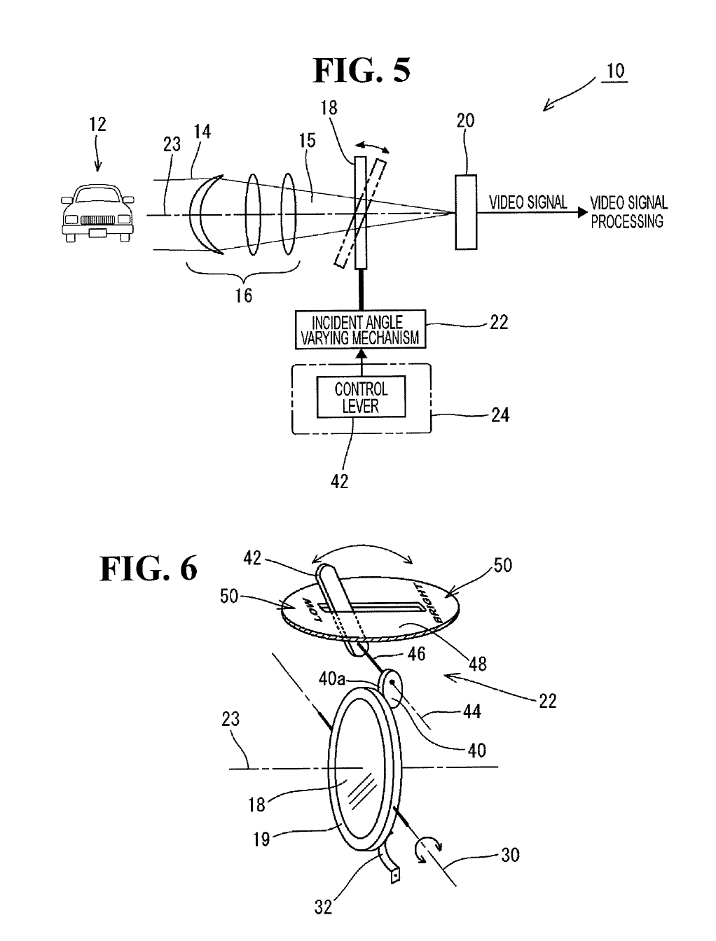

A second embodiment of the present invention is shown in FIG. 5. According to the present embodiment, the incident angle of the infrared cut filter is varied in mechanical response to the operator's manual operation performed according to the amount of light on the subject. The same components as those in the first embodiment are denoted by the same reference numerals as the corresponding components in the first embodiment. The drive unit 24 includes a controller (control lever) 42 manually operated by the operator according to the amount of light on the subject 12. The control lever 42 is mechanically coupled to the incident angle varying mechanism 22 and adapted to drive the incident angle varying mechanism 22 in mechanical response to manual operation of the control lever 42. Consequently, the incident angle of the infrared cut filter 18 is decreased when the amount of light on the subject 12 is small, and increased when the amount of light on the subject 12 is large according to the manual operation.

A configuration example of the control lever 42 and incident angle varying mechanism 22 in FIG. 5 is shown in FIG. 6. The control lever 42 is rotatably supported around a rotation axis 44 by a supporting member (not shown). The cam 40 is fixedly coupled to the rotation axis 44 of the control lever 42 via a coupler 46 and adapted to rotate in response to a turning operation of the control lever 42. By abutting the cam surface 40a of the cam 40 against the holding ring 19 of the infrared cut filter 18 urged by the leaf spring 32 at one location, the cam surface 40a of the cam 40 rotates the infrared cut filter 18 around the rotation axis 30 in response to a turning operation of the control lever 42 to change the incident angle. An operation surface 48 of the control lever 42 is labeled with marks 50 such as “Low” and “Bright” to allow the operator to understand an operating direction of the control lever 42 according to the amount of light on the subject 12. The incident angle of the infrared cut filter 18 is decreased when the control lever 42 is placed in the “Low” position, and increased when the control lever 42 is placed in the “Bright” position.

### Third Embodiment

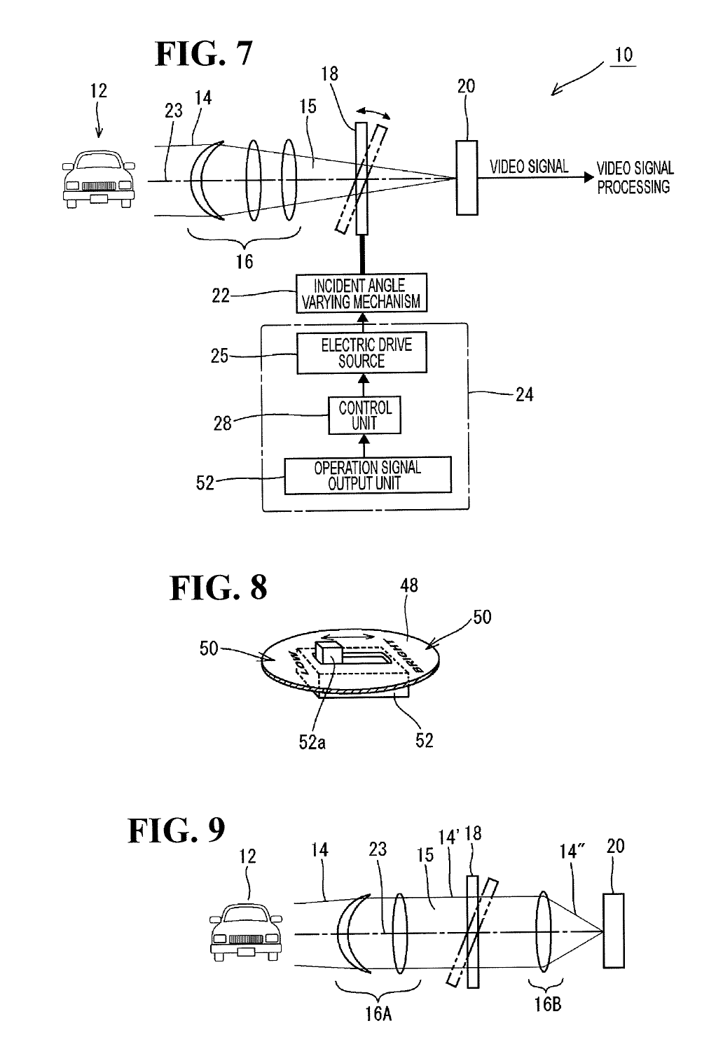

A third embodiment of the present invention is shown in FIG. 7. According to the present embodiment, the incident angle of the infrared cut filter is varied by operating an electric drive source based on an operation signal outputted from an operation signal output unit manually operated by the operator according to the amount of light on the subject. The same components as those in the first embodiment are denoted by the same reference numerals as the corresponding components in the first embodiment. An operation signal output unit 52 is designed to be operated manually by the operator and is made up of, for example, a two-position switch such as shown in FIG. 8. The switch 52 is changed over as the operator slides a controller (switch knob) 52a of the switch. The operation surface 48 of the switch knob 52a is labeled with marks such as “Low” and “Bright” to allow the operator to understand the operating direction of the switch knob 52a according to the amount of light on the subject 12. The control unit 28 receives an operation signal from the operation signal output unit 52 and operates the electric drive source 25 and thereby controls the incident angle of the infrared cut filter 18 by switching between two values via the incident angle varying mechanism 22. Specifically, the incident angle of the infrared cut filter 18 is decreased when the switch knob 52a is slid to the “Low” position, and increased when the switch knob 52a is slid to the “Bright” position. The electric drive source 25 and incident angle varying mechanism 22 can be configured as shown in FIG. 2. The operation signal output unit 52 is not limited to those operated manually, and may be configured to output an operation signal and the like in response to voice and the like of the operator.

### <Another Configuration Example of Optical System>

In the embodiments described above, the infrared cut filter 18 is placed behind the optical system 16, but the infrared cut filter 18 may be placed in front of or in the optical system alternatively. FIG. 9 shows a configuration example in which the infrared cut filter 18 is placed in an optical system. The optical system is made up of a first optical system 16A located in front of the infrared cut filter 18 and a second optical system 16B located behind the infrared cut filter 18. The first optical system 16A captures the image light 14 from the subject 12, converts the image light 14 into parallel light 14′, and allows the parallel light 14′ to enter the infrared cut filter 18. The second optical system 16B receives the image light 14′ passing through the infrared cut filter 18, converts the image light 14′ into focused light 14″, and allows the focused light 14″ to enter the imaging device 20, thereby forming an image on the imaging device 20. Since light incident upon the infrared cut filter 18 has a cross sectional area, if the incident light is focused light, the incident angle varies with the incident region in the cross section, making the cutoff wavelength non-uniform, but with the configuration of the optical system in FIG. 9, since the image light 14 is converted into the parallel light 14′ before entering the infrared cut filter 18, the variation of the incident angle with the incident region in the cross section of the image light 14′ is eliminated, making the cutoff wavelength uniform.

Although in the embodiments described above, the incident angle of the infrared cut filter is switched between two values according to the amount of light on the subject, the incident angle may be switched among multiple steps or varied steplessly according to the amount of light on the subject.

The color camera according to the present invention can be used, for example, for the following applications.

Vehicle-mounted video camera which displays video images around the vehicle (e.g., behind the vehicle) on a vehicle-mounted display screen

Surveillance video camera

Camcorder

Digital camera

Other movie cameras and still cameras

What is claimed is:

1. A color camera comprising:
an optical system adapted to focus image light from a subject;
an imaging device having sensitivity to at least the visible to near-infrared region and adapted to project an image focused by the optical system and thereby generate a video signal;
a multilayer infrared cut filter placed at any location on an optical path running from the subject to the imaging device, with a cutoff wavelength being set in the vicinity of a boundary between the visible region and the near-infrared region, and adapted to allow passage of the near-infrared region close to the boundary with the visible region when an incident angle is small and shift the cutoff wavelength toward shorter wavelengths with increases in the incident angle to decrease passage of the near-infrared region;
an incident angle varying mechanism adapted to vary the incident angle of the image light from the subject with respect to the multilayer infrared cut filter; and
a drive unit adapted to drive the incident angle varying mechanism according to the amount of light on the subject by an operator's operation or automatically and thereby decrease the incident angle when an amount of light on the subject is small or increase the incident angle when the amount of light on the subject is large.

2. The color camera according to claim 1, wherein the drive unit comprises:
an electric drive source adapted to vary the incident angle by electrically operating the incident angle varying mechanism;
a light level detector adapted to detect the amount of light on the subject; and
a control unit adapted to automatically operate the electric drive source according to the amount of light detected by the light level detector and thereby decrease the incident angle when the detected amount of light is small or increase the incident angle when the detected amount of light is large.

3. The color camera according to claim 1, wherein the drive unit comprises a controller adapted to drive, when manually operated by an operator, the incident angle varying mechanism in mechanical response to the manual operation and thereby decrease the incident angle when the amount of light on the subject is small or increase the incident angle when the amount of light on the subject is large.

4. The color camera according to claim 1, wherein the drive unit comprises:
an electric drive source adapted to vary the incident angle by electrically operating the incident angle varying mechanism;
an operation signal output unit adapted to be operated by an operator and output an operation signal according to the operation by the operator.
a control unit adapted to operate the electric drive source according to the operation signal outputted from the operation signal output unit and thereby decrease the incident angle when the detected amount of light is small or increase the incident angle when the detected amount of light is large.

5. The color camera according to claim 1, wherein the multilayer infrared cut filter has a property that a cutoff wavelength at a 50% transmittance shifts 100 nm or more when the incident angle changes from 0° to 60° or vice versa.

6. The color camera according to claim 2, wherein the multilayer infrared cut filter has a property that a cutoff wavelength at a 50% transmittance shifts 100 nm or more when the incident angle changes from 0° to 60° or vice versa.

7. The color camera according to claim 3, wherein the multilayer infrared cut filter has a property that a cutoff wavelength at a 50% transmittance shifts 100 nm or more when the incident angle changes from 0° to 60° or vice versa.

8. The color camera according to claim 4, wherein the multilayer infrared cut filter has a property that a cutoff wavelength at a 50% transmittance shifts 100 nm or more when the incident angle changes from 0° to 60° or vice versa.

9. The color camera according to claim 1, wherein the multilayer infrared cut filter has a property that a cutoff wavelength at a 50% transmittance shifts toward a longer wavelength than 750 nm at an incident angle of 0°, and shifts toward a shorter wavelength than 750 nm at an incident angle of 60°.

10. The color camera according to claim 2, wherein the multilayer infrared cut filter has a property that a cutoff wavelength at a 50% transmittance shifts toward a longer wavelength than 750 nm at an incident angle of 0°, and shifts toward a shorter wavelength

11. The color camera according to claim 3, wherein the multilayer infrared cut filter has a property that a cutoff wavelength at a 50% transmittance shifts toward a longer wavelength than 750 nm at an incident angle of 0°, and shifts toward a shorter wavelength than 750 nm at an incident angle of 60°.
than 750 nm at an incident angle of 60°.

12. The color camera according to claim 4, wherein the multilayer infrared cut filter has a property that a cutoff wavelength at a 50% transmittance shifts toward a longer wavelength than 750 nm at an incident angle of 0°, and shifts toward a shorter wavelength than 750 nm at an incident angle of 60°.

13. The color camera according to claim 5, wherein the multilayer infrared cut filter has a property that a cutoff wavelength at a 50% transmittance shifts toward a longer wavelength than 750 nm at an incident angle of 0°, and shifts toward a shorter wavelength than 750 nm at an incident angle of 60°.
